(19) United States
(12) Patent Application Publication
(10) Pub. No.: US 2016/0061600 A1
(43) Pub. Date: Mar. 3, 2016

(54) ADAPTIVE DETECTION OF USER PROXIMITY

(71) Applicant: MOTOROLA MOBILITY LLC, Chicago, IL (US)

(72) Inventors: Parikshit Dharawat, Sunnyvale, CA (US); Kristin A. Gray, San Mateo, CA (US)

(21) Appl. No.: 14/470,981

(22) Filed: Aug. 28, 2014

(51) Int. Cl. G01B 21/16

(52) U.S. Cl. CPC G01B 21/16

(57) ABSTRACT

This disclosure describes techniques and apparatuses for implementing adaptive detection of user proximity. These techniques and apparatuses enable a device to detect, via environmental variances, proximity of a user and then trigger functions of the device based on the user proximity. The device may also determine if conditions of an environment caused false detection of an environmental variance, in which case, the environmental variance may be disregarded to prevent false triggering of the device functions.

### BACKGROUND

This background description is provided for the purpose of generally presenting the context of the disclosure. Unless otherwise indicated herein, material described in this section is neither expressly nor impliedly admitted to be prior art to the present disclosure or the appended claims.

Many computing devices, such as mobile phones, tablet computers, and portable media devices, receive notifications that include text or other content. When a notification is received by a device, a display of the device can be activated to indicate reception of the notification. Activating the display when each notification is received, however, increases consumption of the device's power and other resources.

As such, some devices attempt to conserve power by limiting the indication of notifications, or other device functions, to situations in which a user is available to view the indications or interact with the device. To do so, the devices typically rely on sensor data to detect the user's presence or proximity Sensor data associated with some ambient conditions, however, may lead to false detection of the user's presence or proximity. Accordingly, false detections that result in inadvertent indication of notifications can defeat, at least in part, the power conservation efforts of these devices.

### BRIEF DESCRIPTION OF THE DRAWINGS

Embodiments of adaptive detection of user proximity are described with reference to the following Figures. The same numbers may be used throughout to reference like features and components that are shown in the Figures:

FIG. 1 illustrates an example environment in which techniques for adaptive detection of user proximity can be implemented.

FIG. 2 illustrates a wireless network implemented in accordance with one or more aspects of adaptive detection of user proximity.

FIG. 3 illustrates an example method for preventing false triggering of a device function.

FIG. 4 illustrates an example method for preventing false detection of environmental variances.

FIG. 5 illustrates an example environment in which aspects of adaptive detection of user proximity are implemented.

FIG. 6 illustrates an example method for implementing adaptive detection of user proximity in a group of devices.

FIG. 7 illustrates an environment in which a group of devices can implement one or more aspects of adaptive detection of user proximity.

FIG. 8 illustrates various components of an example electronic device that can implement embodiments of adaptive detection of user proximity.

### DETAILED DESCRIPTION

Conventional techniques for detecting user proximity may falsely detect a presence or proximity of a user based on ambient conditions of an environment. These false detections may occur when the ambient conditions of the environment approximate or replicate environmental variances associated with the user. In such cases, the conventional techniques may not be able to discern these ambient conditions from the environmental variances associated with, or caused by, the user (e.g., gesture input). For example, a smart phone may be configured to detect the presence of a user in response to motion or movement of the smart phone. When the smart phone is placed on a car seat, the smart phone may falsely detect the presence of user due to motion of the smart phone caused by vibration or movement of the car.

When a device is configured to implement functions based on, or in response to, proximity of a user, the functions may be inadvertently triggered due to this false detection of the user. For devices that attempt to conserve power, such as those devices that implement low-power states in which functionality of the device is limited, the inadvertent triggering of functions can consume substantial power and other resources of the device. Accordingly, the false detection of user proximity (or interaction) may effect a runtime of the device or availability of the device's resources.

This disclosure describes techniques and apparatuses for adaptive detection of user proximity, which enable a computing device to determine, based on detection of environmental variances associated with a user, proximity of the user. In response to determining the proximity of the user, functions of the device may be triggered. The device may also disregard, when conditions of an environment cause false detection of an environmental variation, the falsely detected environmental variance effective to prevent false triggering device functions. Alternately or additionally, the device may cause other devices to disregard environmental variances effective to prevent false triggering of respective functions of the other devices. By so doing, power of the device, and/or other devices, can be conserved by preventing false triggering of the devices' respective functions.

The following discussion first describes an operating environment, followed by techniques that may be employed in this environment, and ends with example apparatuses.

### Operating Environment

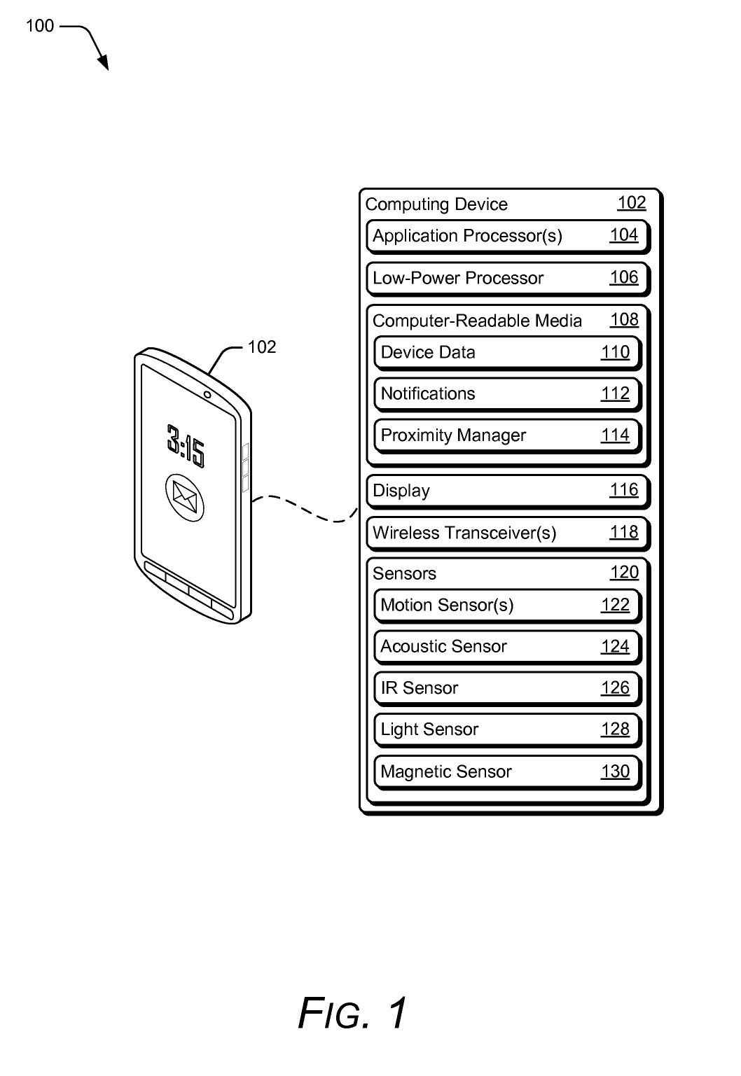

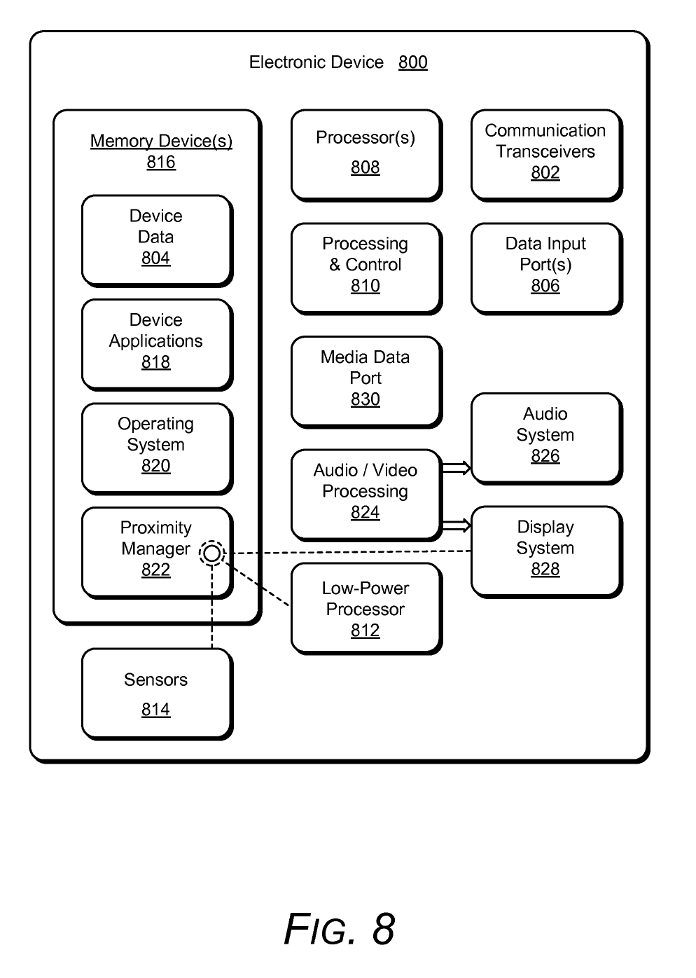

FIG. 1 illustrates an example environment 100 in which embodiments of adaptive detection of user proximity can be implemented. Example environment 100 includes a computing device 102, which in this particular example is implemented as smart phone 102. Computing device 102 may be implemented as any suitable type of electronic device, such as a smart-phone, mobile phone, tablet computer, handheld navigation device, portable gaming device, net book, and/or portable media playback device. Computing device 102 may also be any type of device as further described with reference to the example electronic device shown in FIG. 8. Computing device 102 has multiple operational states, which range from a fully-on state to a fully-off state. The operational states may include a low-power state (e.g., sleep state) in which various components of the device enter respective low-power states to conserve power.

Computing device 102 includes an application processor 104 and a low-power processor 106. Application processor 104 may be configured as a single or multi-core full-power processor that includes graphic rendering capabilities. Application processor 104 may also include multiple operation states, including a full-power state (e.g., full-on state) and a low-power state (e.g., a sleep state) in which functionalities of the application processor 104 are unavailable. Alternately in the full-power state, application processor 104 may implement any or all functions of computing device 102, such as graphical processing, data communication, content creation, media playback, and so on. In some embodiments, causing application processor 104 to enter the low-power state is effective to conserve power of the computing device 102.

Low-power processor 106 may be configured as a low-power processor or micro-controller that is unable to perform processor-intensive functions, such as those implemented by application processor 104. For example, low-power processor 106 may be unable to fully implement an operating system of computing device 102. In at least some embodiments, however, low-power processor can perform other tasks, such as rendering basic graphics and images, processing sensor data, providing limited-communicative service, and the like. For example, low-power processor 106 may enable computing device to receive, or generate previews of, notifications while computing device 102 and/or application processor 104 are in respective low-power states.

In some embodiments, low-power processor 106 may be a processor in a low-power state in which capabilities of the processor are limited. For example, a low-power processor may be implemented by causing a higher-power processor, or processor core, to enter a low-power state in which capabilities of the higher-power processor are reduced. When computing device 102 is in a sleep state, low-power processor 106 can manage various input/output functionalities or background tasks. Low-power processor 106 may be implemented as a reduced-instruction set computing (RISC) processor which has a smaller instruction set, operates at a lower frequency, or has fewer processing capabilities than application processor 104.

For example, when application processor 104 is configured as a multi-core full-power processor implementing a 32-bit instruction set, low-power processor 106 may be configured as a RISC-based micro-controller that implements a 16-bit instruction set. Application processor 104 and/or low-power processor 106 may each be implemented separately as disparate components (shown), or implemented together as an application processor with integrated companion micro-controller (not shown).

Computing device 102 also includes computer readable-media 108 (CRM 108), which stores device data 110 and notifications 112 of computing device 102. CRM 108 may include any suitable memory or storage device implemented at least in part as a physical device, which does not include propagating signals or waveforms. Example memory types of devices include random-access memory (RAM), static RAM (SRAM), dynamic RAM (DRAM), non-volatile RAM (NVRAM), read-only memory (ROM), or Flash memory useful to store the device data 110, notifications 112, or metadata.

Device data 110 may include user data, multimedia content, applications and/or an operating system of computing device 102, which are executable by application processor 104 to provide various functionalities of the computing device 102. Notifications 112 may include messages or alerts received by computing device 102 from external sources, such as servers, messaging applications, social networks, and the like. In some cases, notifications 112 are received while computing device 102 is in a low-power state. A notification 112 may notify the user of one of an email, a short message service (SMS) message, a multimedia messaging service (MMS) message, a picture message, an internet link, a video message, a missed-call alert, a software update, a social-media message, an application-specific alert, and so on.

Each notification 112 may also notify the user of content, such as text, a picture, video content, sound content, metadata, origination information, or contact information. In some embodiments, a type of notification is associated with one or more applications of computing device 102. For example, MMS messages can be associated with a messaging application to process text and contact information, and a multimedia application to render images, sound, or video associated with the MMS messages.

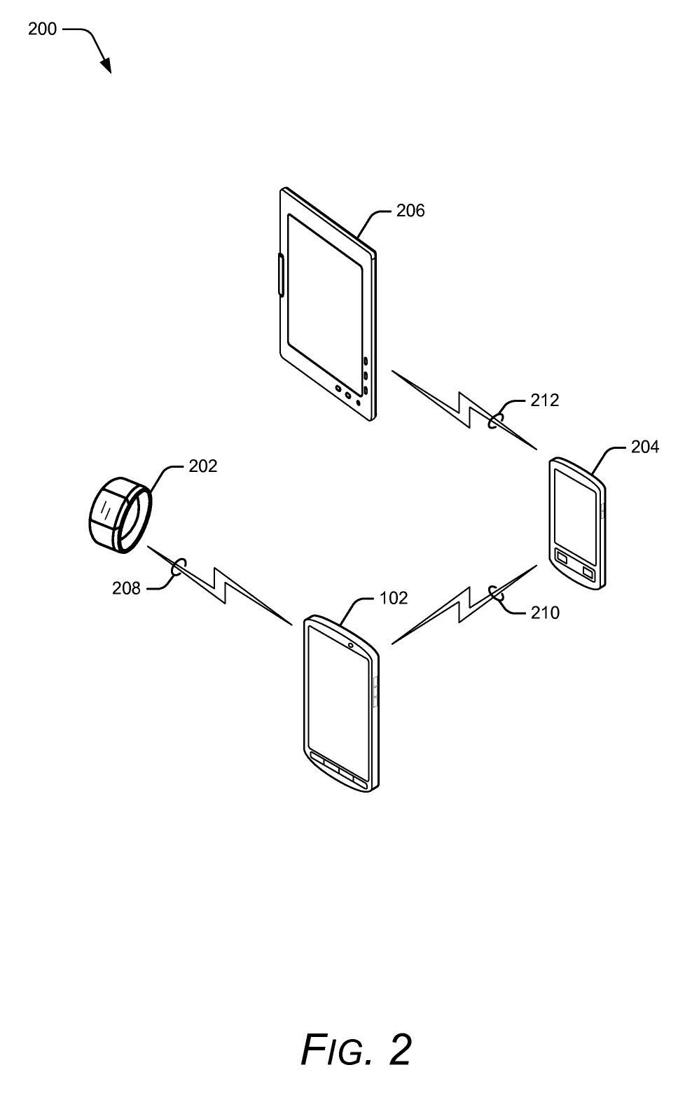

Computing device 102 also includes proximity manager 114, which, in one implementation, is embodied on CRM 108 (as shown) as processor-executable instructions. Alternately or additionally, proximity manager 114 may be implemented in whole or part as hardware logic or circuitry integrated with or separate from other components of the computing device 102 (e.g. the application processor 104 or low-power processor 106). Example implementations of proximity manager 114 are described further with reference to FIGS. 2-8. In at least some embodiments, the proximity manager 114 enables computing device 102 to detect proximity of a user.

Computing device 102 also includes display 116 for presenting visual content to users. Display 116 may be configured as any suitable type of display, such as a liquid crystal display (LCD) or an active-matrix organic light-emitting diode (AMOLED) display. Visual content presented by display 116 is based on display data received from other components of the computing device 102. This display data is typically processed by application processor 104 or low-power processor 106, either of which may also cause display 116 to present some or all of the display data.

Computing device 102 is capable of communicating data via a wireless transceiver(s) 118, which may include any suitable number or type of wireless data interfaces. Each wireless transceiver 118 may be configured for communication via one or more types of data networks, such as a wireless personal-area-network (WPAN), wireless local-area-network (WLAN), wireless wide-area-network (WWAN), or a cellular network. Example standards by which these networks communicate include IEEE 802.15 (Bluetooth™) standards, IEEE 802.11 (WiFi™) standards, 3GPP-compliant cellular standards, or various IEEE 802.16 (WiMAX™) standards. In some embodiments, notifications 112 are received from remote sources via wireless transceivers 118. Alternately or additionally, computing device 102 may communicate directly, or indirectly, with other devices via peer-to-peer networks, mesh networks, or other communicate links established using wireless transceivers 118.

Although not shown, computing device 102 may also include wired data interfaces for communicating with other devices, such as a universal serial bus (e.g., USB 2.0 or USB 3.0), audio, Ethernet, peripheral-component interconnect express (PCI-Express), serial advanced technology attachment (SATA), and the like. In some embodiments, the wired data interface may be operably coupled with a custom or proprietary connector which integrates multiple data interfaces, along with a power connection for charging the computing device 102.

Sensors 120 enable computing device 102 to sense various properties, conditions (e.g., ambient conditions), variances, stimuli, or characteristics of an environment in which computing device 102 operates. In this particular example, sensors 120 include motion sensor 122, acoustic sensor 124, infrared sensor 126 (IR sensor 126), light sensor 128, and magnetic sensor 130. Although not shown, sensors 120 may also include temperature/thermal sensors, proximity sensors, global-positioning modules, micro-electromechanical systems (MEMS), capacitive touch sensors, and so on. Alternately or additionally, sensors 120 enable interaction with, or receive input from, a user of computing device 102. In such a case, sensors 120 may include piezoelectric sensors, cameras, capacitive touch sensors, input sensing-logic associated with hardware switches (e.g., keyboards, snap-domes, or dial-pads), and so on.

Motion sensors 122 include accelerometers or motion sensitive MEMS configured to sense movement or orientation of computing device 102. Motion sensors 122 can sense movement or orientation in any suitable aspect, such as in one-dimension, two-dimensions, three-dimensions, multi-axis, combined multi-axis, and the like. In some embodiments, motion sensors 122 enable computing device 102 to sense gesture inputs (e.g., a series of position and/or orientation changes) made when a user moves computing device 102 in a particular way. Motion sensors may also enable computing device to detect or characterize ambient movement or other conditions of the environment.

Acoustic sensor 124 may include a microphone or acoustic wave sensor configured to monitor sound of an environment in which computing device 102 operates. Acoustic sensor 124 is capable of receiving voice input of a user, which can then be processed by a digital-signal-processor (DSP) or processor of computing device 102. Sound captured by acoustic sensors 124 may be analyzed or measured for any suitable component, such as pitch, timbre, harmonics, loudness, rhythm, envelope characteristics (e.g., attack, sustain, decay), and so on. In some embodiments, computing device 102 identifies or differentiates users based on input received from acoustic sensors 124.

IR sensor 126 is configured to detect thermal changes of an environment or provide infrared (IR) imagery of the environment. In some cases, IR sensor 126 enables computing device to detect thermal variances that indicate proximity of a user. For example, IR sensor 126 may detect a heat signature associated with a user or a body part of the user when the user is proximate computing device 102. IR sensor 126 may be implemented as an IR camera configured for thermal imaging (e.g., a thermal camera or thermal sensor), a standard camera with an IR filter, or any other suitable IR related sensor.

Light sensor 128 may include an ambient light sensor, optical sensor, or photo-diode configured to sense light around computing device 102. Light sensor 128 is capable of sensing ambient light or directed light, which can then be processed by a DSP or processor of computing device 102 to determine whether a user is interacting with computing device 102. For example, changes in ambient light may indicate that a user has picked up computing device 102 (e.g., turned the device over) or removed computing device 102 from his or her pocket.

Magnetic sensor 130 may include a hall-effect sensor, magneto-diode, magneto-transistor, magnetic sensitive MEMS, or magnetometer configured to sense magnetic field characteristics around computing device 102. Magnetic sensors 130 may sense a change in magnetic field strength, magnetic field direction, or magnetic field orientation. In some embodiments, computing device 102 determines proximity with a user or another device based on input received from magnetic sensors 134.

In some embodiments, sensors 120 are operably coupled with low-power processor 106 and/or proximity manager 114, which can be configured to receive input from sensors 120 while computing device 102 is in a sleep state (e.g., low-power state). Proximity manager 114 is capable of processing the input from sensors 120 to detect properties or variances of an environment in which computing device 102 operates. For example, Proximity manager 114 can determine an orientation of, or gestures performed with, computing device 102 with respect to a three-dimensional coordinate system via accelerometers.

In some embodiments, detection of environmental variances can trigger functions of computing device 102 or cause computing device 102, or components thereof, to transition between power states. In some cases, sensor manager is configured to detect environmental variance that are associated with, or indicate proximity of, a user. In such cases, sensor data can be compared to a threshold or profile useful to detect an environmental variance associated with the user. In such cases, the threshold or profile for the sensor data may include any suitable criteria, such as amplitude(s), rates of change, envelopes, states, and the like. For example, criteria for detecting a user-based gesture (e.g., shake event) may include amplitude thresholds for sensed movement along an X-axis, Y-axis, or Z-axis. Input received from sensors 120 may also be sent to applications executing on application processor 104 to enable environmental-based functionalities of the applications.

FIG. 2 illustrates an example wireless network 200 implemented in accordance with one or more aspects of adaptive detection of user proximity. In this particular example, smart phone 102 communicates with other computing devices, which include smart watch 202, personal media device 204, and tablet computer 206. Each of these devices may be implemented similar to, or differently from, computing devices 102. Here, smart phone 102 is configured to implement a network over a wireless personal-area-network (PAN), such as a Bluetooth™ pico-net or mesh network. Alternately or additionally, smart phone 102 can communicate directly, or indirectly, with the computing devices 202-206 using any suitable type of wireless transceiver or protocol, such as a WLAN network or communication link (Wife Direct).

Wireless network 200 can be implemented as a mesh network that enable direct or indirect communication between various devices. In this particular example, smart phone 102 communicates with smart watch 202 and personal media device 204 via wireless data links 208 and 210, respectively. Additionally, smart phone 102 can communicate with tablet computer 206 by a direct wireless link (not shown) or by transmitting data to personal media device 204, which can be configured to forward data to tablet computer 206 via wireless data link 212. Alternately or additionally, any of the computing devices may also communicate with other wireless data networks, such as cellular networks, while associated with wireless network 200.

In some embodiments, wireless network 200 enables smart phone 102 to communicate data with other computing devices 202-206. In some cases, signals or indications transmitted by smart phone 102 can cause the other computing devices to perform various operations, provide information, or configure respective functionality of the other computing device. In other cases, any or all of the computing devices of wireless network 200 can share content, notifications, or other information of a single one of the computing devices.

Wireless data links 208-212 of wireless network 200 may be implemented as low-power or background communication links. This may be effective to permit data to be communicated to, or from, a computing device in a low-power state. For example, smart phone 102 may query smart watch 202 for its respective sensor information while either or both devices are in respective low-power states. By so doing, one or more of the wireless data links can be used and/or maintained without waking a respective one of the devices, thereby permitting the respective device to conserve power.

### Example Techniques for Adaptive Detection of User Proximity

The following discussion describes techniques for adaptive detection of user proximity, which enable a device to determine if ambient conditions resulted in detection of an environmental variance indicative of user proximity. When it is determined that detection of the environmental variance is caused by the ambient conditions, the device can disregard the environmental variance. By so doing, false triggering of device functions can be prevented, which may enable conservation of device power and other resources.

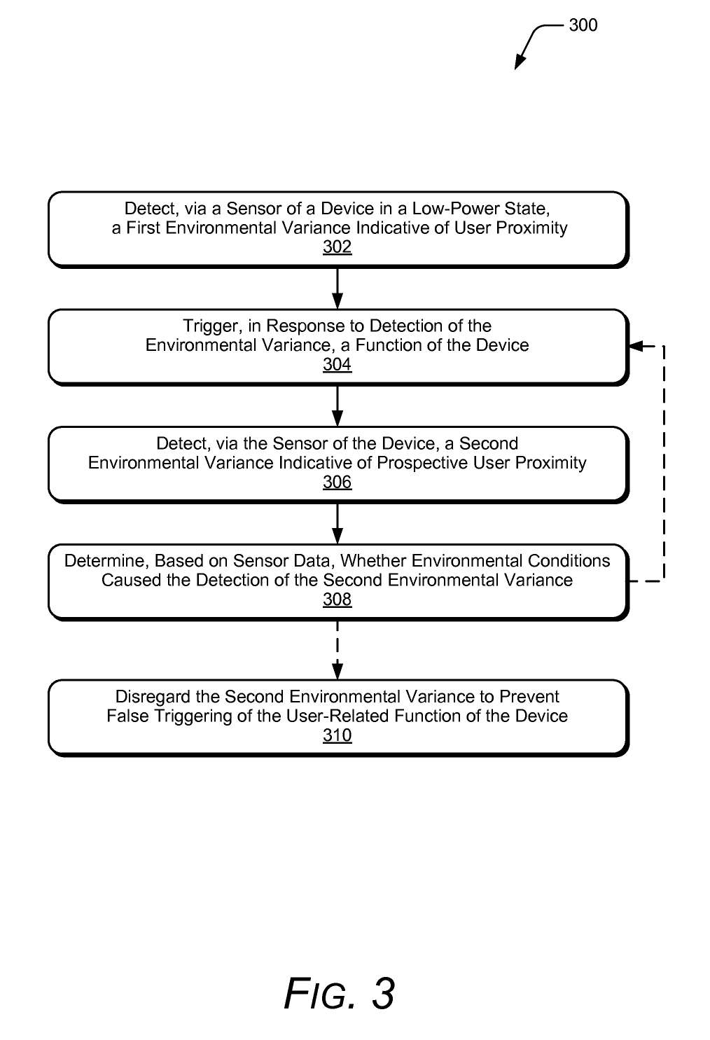

These techniques can be implemented utilizing the previously described environment, such as computing device 102, low-power processor 106, and/or proximity manager 114 of FIG. 1. These techniques include example methods illustrated in FIGS. 3, 4, and 6, which are shown as operations performed by one or more entities. The orders in which operations of these methods are described are not intended to be construed as a limitation, and any number or combination of the described method operations can be combined in any order to implement a method, or an alternate method, including any of those illustrated by FIGS. 3, 4, and 6.

FIG. 3 illustrates example method(s) 300 for preventing false triggering of a device function, including operations performed by proximity manager 114 of FIG. 1.

At 302, a first environmental variance is detected via a sensor of a device. The first environmental variance may indicate a presence or proximity of a user or may be associated with the user. In some cases, the first environmental variance is detected while the device is in a low-power mode in which a display or other components of the device are not powered or active. The first environmental variance may be any suitable type of variance sensed at the device, such as motion, sound, temperature, light, or magnetic field strength or direction.

Consider an example in which a user is riding in a car and desires to check her smart phone for any pending notifications. Here, assume that her smart phone is configured to dwell in a low-power state to conserve power until user proximity is detected. To activate notification features of her smart phone, the user shakes the smart phone in an X-Y plane of motion (e.g., shake gesture). In response to the shaking motion, proximity manager 114 of the smart phone detects, via motion sensor 122, the motion in the X-Y plane.

At 304, a function of the device is triggered in response to detecting the first environmental variance. This can be effective to enable users to invoke or trigger functions of the device through proximity or indirect interaction. For example, a user may trigger a function of a device by waving his hand over the device, speaking to the device, flipping the device over, or by shaking the device. In some cases, particular functions of the device are mapped to corresponding environmental variances, such as user proximity, movement, or gestures.

In some embodiments, the function is performed while the device in a low-power state, which enables the device to conserve power. In some cases, the function is implemented by a low-power processor of the device while an application processor is in a low-power state. In such cases, the functions implemented by the low-power processor may include presenting a preview of content corresponding to the notification, communicating content with another device, initiating authentication operations, and the like.

In the context of the present example, proximity manager 114 triggers, in response to the detected motion, a preview of content corresponding to the notification. Here, assume that proximity manager 114 is configured to map a shake gesture to the preview function. Once the preview function is triggered, proximity manager 114 causes display 116, or a portion thereof, to activate to present the preview of the notification content. Note that the preview of the content corresponding to the notification is presented while the smart phone is in a low-power state, which, in contrast to fully-activating the smart phone, conserves power and other resources of the smart phone.

At 306 a second environmental variance is detected via the sensor of the device. The second environmental variance may also indicate a presence or proximity of a user or may be associated with the user. In some cases, the second environmental variance is detected within a duration of time following detection of the first environmental variance. The environmental variance may be any suitable type of variance sensed at the device, such as motion, sound, temperature, light, or magnetic field strength or direction.

Continuing the ongoing example, assume that the user has placed her phone on the dashboard of the car she is travelling in. Here, due to movement of the car, proximity manager 114 detects, via motion sensor 122, motion in the X-Y plane that exceeds an amplitude threshold for detecting a shake gesture. Although the user is not shaking her phone, a potential shaking gesture is detected because the motion exceeds the amplitude threshold.

At 308, a cause for detection of the second environmental variance is determined The cause for detection of the second environmental variance may be subsequent user proximity or user interaction. Alternately, ambient conditions of an environment in which the device is operating may cause false detection of the environmental variance. In some cases, the ambient environmental conditions (environmental conditions) may cause, or lead to, the false detection of one or more instances of an environmental variance. The environmental conditions can be determined by analyzing sensor data associated with detection of the first or the second environmental variances. Alternately, additional sensor data useful to determine the environmental conditions may be received or collected at predefined intervals, at random times, or in response to detection of an environmental variance.

When the environmental conditions exceed thresholds or profiles for detecting the environmental variances that indicate user proximity or interactions, the environmental conditions may cause false detection of the environmental variance. In some cases, a probability of false detection (e.g., numerical score) can be calculated based on the environmental conditions and a set of predefined criteria. The predefined criteria may include any suitable type of criteria, such as profiles, thresholds, patterns associated with detecting environmental variances associated with a user. The cause of detecting the second environmental variance can be determined using the determined probability. For example, if the probability exceeds a predefined threshold (e.g., 50%), the cause for detecting the second environmental variance is determined to be the environmental conditions instead of proximity or interaction with a user.

In the context of the present example, proximity manager 114 analyzes data of motion sensor 122 to detect ambient conditions in which the smart phone is operating. Due to the movement of the car, sensor manager detects constant movement in the X-Y plane, which is sufficient to cause multiple detections of a shake gesture. By analyzing the sensor data based on a set of predefined criteria for movement in the X-Y plane, motion sensor 122 determines that the recent detection of the shake gesture is being caused by ambient movement of the environment of the smart phone.

From operation 308, method 300 may return to operation 304 or proceed to operation 310. If it determined that a user caused detection of the second environmental variance, method 300 returns to operation 304 to trigger a function of the device. As described at operation 304, the function triggered may correspond to detection of an environmental variance to which the function is mapped, such as a tap gesture triggering display of time. If it is determined that environmental conditions caused detection of the second environmental variance, method 300 proceeds to operation 310.

At 310, the second environmental variance is disregarded. This can be effective to present false triggering of a function of the device. In some cases, subsequently detected environmental variances are also disregarded. In such cases, the environmental variances may be disregarded for a predefined amount of time (e.g., one second to one minute) effective to prevent false triggering of the function for at least that amount of time. For example, a sensor-based trigger mode of a device may be disabled in response to determining that environmental conditions are likely to cause multiple false detections of an environmental variance associated with a user.

Concluding the present example, proximity manager 114 ceases to monitor motion sensor 122 for five seconds in response to determining that ambient movement of the car is capable of causing false detection of the shake gesture. After five seconds elapse, proximity manager 114 may resume monitoring motion sensor 122 to detect subsequent shake gestures. In response to false detection of another shake gesture, note that proximity manager 114 may be configured to cease to monitor motion sensor 122 for an increased an amount of time, such as ten or twenty seconds. By so doing, a frequency of detection can be reduced while in the car, which enables the smart phone to conserve additional power and other resources.

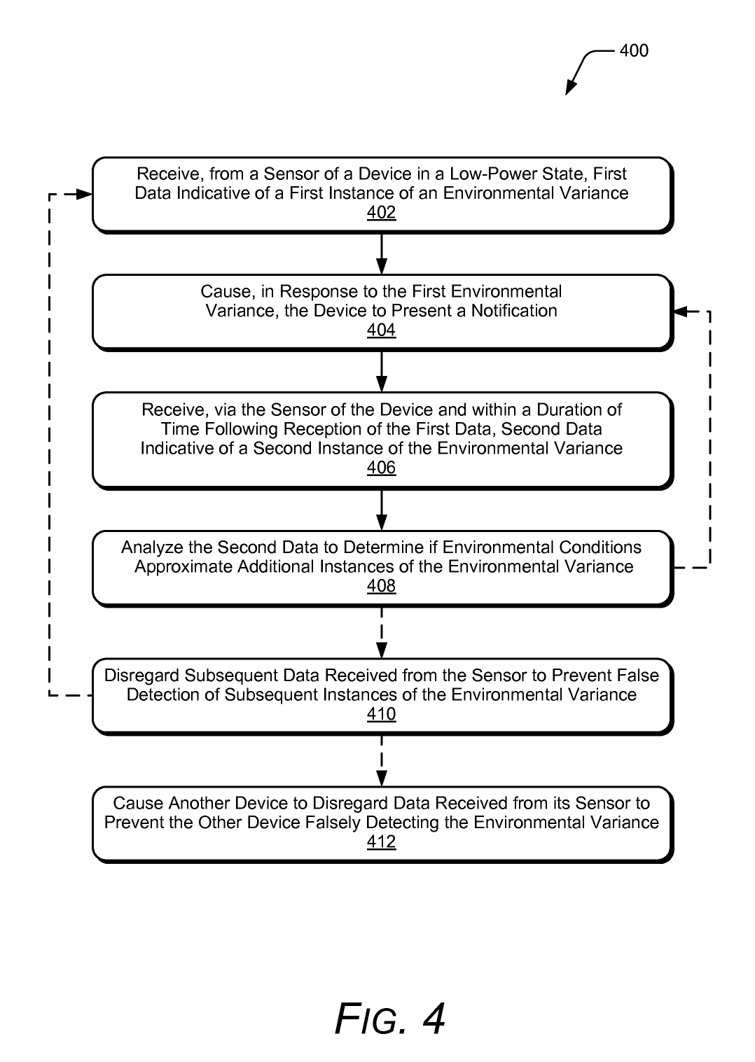

FIG. 4 illustrates an example method for preventing false detection of environmental variances, including operations performed by proximity manager 114 of FIG. 1.

At 402, first data indicative of a first instance of an environmental variance is received from a sensor. The environmental variance may indicate potential user proximity or potential user interaction, such as a shake or tap gesture. The sensor may be any suitable sensor of a device, such as an acoustic sensor, motion sensor, thermal sensor, magnetic sensor, light sensor, and the like. In some cases, the device is in a low-power mode and the sensor is monitored by a low-power processor of the device to conserve power.

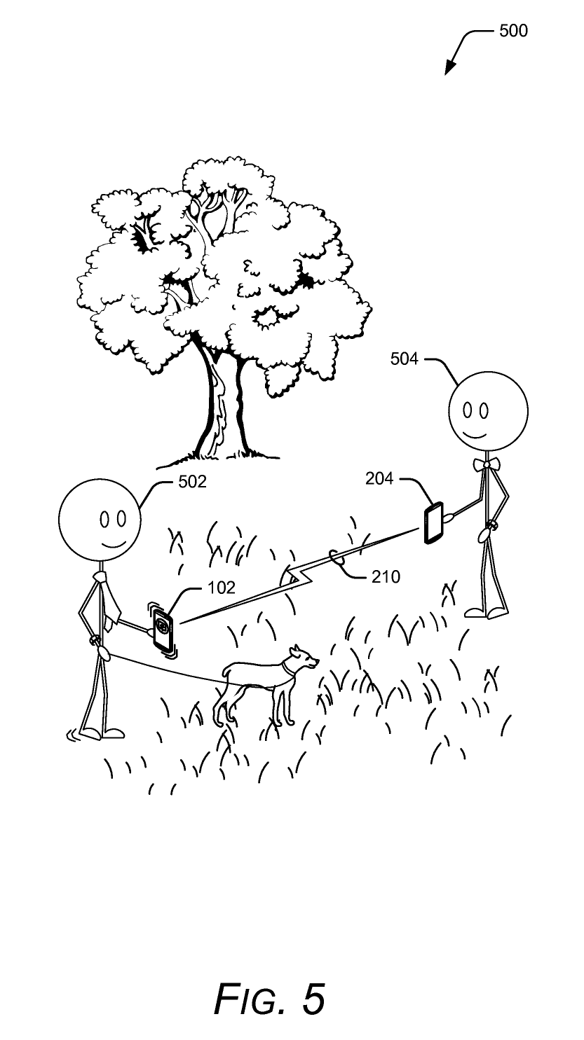

As an example, consider FIG. 5 in which user 502 is shown walking through a park with smart phone 102. Here, assume that the user shakes smart phone 102 to view a preview of a notification that was received while smart phone 102 was in a low-power mode. Proximity manager 114 of smart phone 102 receives data from motion sensor 122 that indicates movement as a result of the shake gesture.

At 404, the device is caused to present a notification in response to the first instance of the environmental variance. Alternately or additionally, the device may be caused to present information, such as a time or date. In some cases, the device may be configured to invoke or trigger various functions in response to detecting respective environmental variances that indicate a presence or proximity of a user. The device may present the notification, or a preview of the content corresponding to the notification, while the device is in a low-power mode. By so doing, the notification can be presented without activating high-power components of the device, which enables the device to conserve power. In the context of the present example, proximity manager 114 causes smart phone 102 to present content corresponding to a notification via display 116.

At 406, second data indicative of a second instance of the environmental variance is received. The second data is received within a duration of time following reception of the first data. In some cases, the second data is received while the device is in a low-power mode and may be processed by a low-power processor of the device. The second data may also be useful to determine environmental conditions in which the device is operating. Continuing the ongoing example, proximity manager 114 continues to receive data from motion sensor 122. Here, note that this motion data is caused by a walking motion of user 502 rather than a deliberate shake gesture.

At 408, the second data is analyzed to determine if environmental conditions approximate one or more additional instances of the environmental variance. This may be effective to determine the presence of environmental conditions that could result in one or more false detections of the environmental variance associated with the user. Optionally, method 400 may return to operation 404 if the environmental conditions do not approximate additional instance of the environmental variance. In some cases, returning to operation 404 is effective to cause the device to present another notification. In the context of the present example, proximity manager 114 analyzes the motion data caused by user 502 walking. Here, proximity manager 114 determines that the motion data is sufficient to cause multiple detections of a shake event at a frequency above a predefined threshold.

At 410, subsequent data received from the sensor is disregarded to prevent false detection of subsequent instances of the environmental variance. This can be effective to prevent false triggering of a device function that corresponds to detection of the environmental variance. In some cases, a sensor-reactive mode of the device is disabled, such as a mode configured to present notifications in response to gesture input. Alternately or additionally, the subsequent data is disregarded or ignored for a predefined amount of time (e.g., one second to one minute) effective to prevent false triggering of the function for at least that amount of time. Once the predetermined amount of time expires, method 400 may return to operation 402 effective to resume monitoring of sensor data for environmental variances.

Continuing the ongoing example, proximity manager 114 ignores subsequent data received from motion sensor 122, but continues to monitor other sensors of smart phone 102. To conserve power of smart phone 102, proximity manager 114 may also power-down motion sensor 122 and associated circuitry for a predefined amount of time (e.g., 5 seconds to one minute).

Optionally at 412, another device is caused to disregard its sensor data to prevent the other device from falsely detecting instances of the environmental variance. When operating as part of a group of devices, this can be effective to prevent the environmental conditions from causing, at the other devices of the group, false detection of environmental variances.

In the context of the present example and referring back to wireless network 200 of FIG. 2, assume smart phone 102 of user 502 and personal media device 204 of user 504 are part of a group that communicates via wireless data link 210. Here, smart phone 102 can determine a distance to personal media device 204 using wireless data link 210. Because of the relative distance between the devices, proximity manager 114 of smart phone 102 causes personal media player to disregard motion sensor input. This can be effective to prevent the walking motion of user 504 from being falsely detected as a shake gesture, which would result in an inadvertent presentation of notifications by personal media device 204.

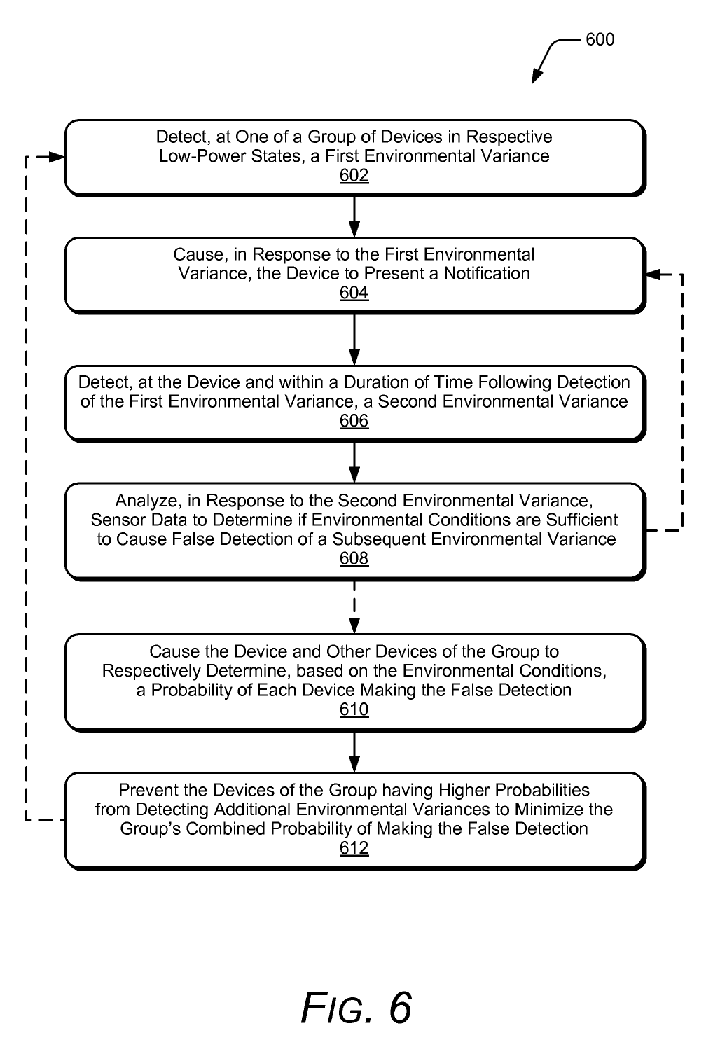

FIG. 6 illustrates an example method for implementing adaptive detection of user proximity in a group of devices, including operations performed by proximity manager 114 of FIG. 1.

At 602, a first environmental variance is detected via a sensor of one of a group of devices. The group of devices may be linked via a wireless data link or wireless network, such as a WLAN or WPAN. Each of the devices may also implement a low-power state in which sensor-based functions are enabled. For example, one or all of the devices may be configured to present a notification or content corresponding to the notification in response to a shake gesture.

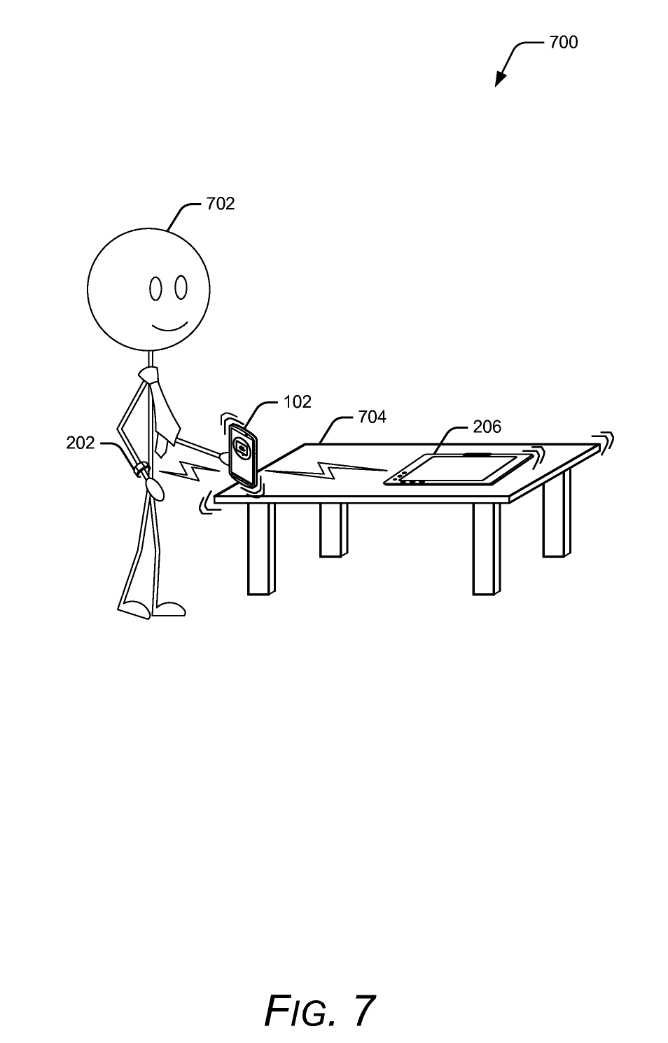

By way of example, consider FIG. 7, which depicts user 702 interacting with smart phone 102. Here, assume that smart phone 102, smart watch 202, and tablet computer 206 communicate via wireless data links as described with reference to FIG. 2. As user 702 shakes smart phone 102, proximity manager 114 detects an environmental variance in the form of movement in the X-Y plane (as depicted in FIG. 7).

At 604, the device is caused to present a notification in response to the first instance of the environmental variance. In some cases, the device may be configured to invoke or trigger various functions in response to detecting respective environmental variances that indicate a presence or proximity of a user. In the context of the present example, proximity manager 114 causes smart phone 102 to present a notification or content corresponding to the notification via display 116, which enables user 702 to view a pending notification or corresponding content.

At 606, a second environmental variance detected at the device. The second environmental variance is detected within a duration of time following detection of the first environmental variance. In some cases, the second environmental variance data is detected while the device is in a low-power mode and may be processed by a low-power processor of the device. The data associated with the second environmental variance may also be useful to determine environmental conditions in which the device is operating. Continuing the ongoing example, proximity manager 114 detects another movement in the X-Y plane. Here, note that this movement is caused by user 702 tossing smart phone 102 on table 704, rather than a deliberate shake gesture.

At 608, sensor data is analyzed by the device to determine if environmental conditions are sufficient to cause false detection of a subsequent environmental variance. This may be effective to determine the presence of environmental conditions that could result in one or more false detections of the environmental variance associated with the user. Optionally, method 600 may return to operation 604 if the environmental conditions are not sufficient to cause false detection of an environmental variance. In some cases, returning to operation 604 is effective to cause the device to present another notification. In the context of the present example, proximity manager 114 analyzes data indicative of ambient environmental conditions that is provided by motion sensor 122. Here, assume that proximity manager 114 determines that the motion was caused by user 702 tossing smart phone 102 onto table 704.

At 610, the device and other devices of the group are caused to respectively determine, based on the environmental conditions, a probability of making a false detection of the environmental variance. Each device of the group may analyze its own respective sensor data to determine a respective one of the probabilities. In some cases, a probability of false detection (e.g., numerical score) can be calculated based on the environmental conditions and a set of predefined criteria. The predefined criteria may include any suitable type of criteria, such as profiles, thresholds, patterns associated with detecting environmental variances associated with a user.

Continuing the ongoing example, proximity manager 114 calculates, based on ambient movement of smart phone 102 and table 704, a numerical probability score of falsely detecting another shake gesture. Proximity manager 114 also causes, via wireless data links, smart watch 202 and tablet computer 206 to calculate respective probability scores. After each device has calculated its respective probability score, proximity manager 114 queries the other devices for their probability scores. Here, assume that smart phone 102 and tablet computer 206 have higher probabilities of falsely detecting a subsequent shake gesture due to the movement of table 704. Conversely, smart watch 202, which is isolated from movement of table 704 by residing on the wrist of user 702, has the lowest probability score of the group.

At 612, devices of the group having higher probabilities of making false detections are prevented from detecting additional environmental variances. This can be effective to minimize the group's combined probability of making a false detection of an environmental variance. In some cases, one or more devices having low probabilities of making false detections continue to monitor respective sensor data. In such cases, the devices having lower probabilities may cause the rest of the group to resume monitoring, such as when a change in environmental conditions is detected. Alternately or additionally, the group of devices may return to normal operation after a predefined amount of time. For example, operation 600 may return to operation 602 after the predetermined amount of time, effective to cause all the devices in the group to resume detection of environmental variances.

Concluding the present example, proximity manager 114 ceases to monitor motion sensor 122 for a predetermined amount of time. Additionally, sensor manager causes, via a wireless data link, tablet computer 206 to cease to monitor its respective motion sensor. The group of the devices may still respond to user interaction or proximity as detected by smart watch 202, which continues to analyze data to detect environmental variances, such as subsequent shake gestures.

Example Electronic Device FIG. 8 illustrates various components of an example electronic device 800 that can be implemented as a computing device as described with reference to any of the previous FIGS. 1-7. The device may be implemented as any one or combination of a fixed or mobile device, in any form of a consumer, computer, portable, user, communication, phone, navigation, gaming, messaging, Web browsing, paging, media playback, and/or other type of electronic device, such as computing device 102 described with reference to FIG. 1 or computing devices 202-206 described with reference to FIG. 2.

Electronic device 800 includes communication transceivers 802 that enable wired and/or wireless communication of device data 804, such as transmitted data and received data (e.g., text messages, email, etc.). Example communication transceivers include wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN, 3GPP-compliant) radios for cellular telephony, wireless metropolitan area network (WMAN) radios compliant with various IEEE 802.16 (WiMAX™) standards, and wired local area network (LAN) Ethernet transceivers.

Electronic device 800 may also include one or more data input ports 806 via which any type of data, media content, and/or inputs can be received, such as user-selectable inputs, messages, music, television content, recorded video content, and any other type of audio, video, and/or image data received from any content and/or data source. Data input ports 806 may include USB ports, coaxial cable ports, and other serial or parallel connectors (including internal connectors) for flash memory, DVDs, CDs, and the like. These data input ports may be used to couple the electronic device to components, peripherals, or accessories such as keyboards, microphones, or cameras.

Electronic device 800 of this example includes a processor system 808 (e.g., any of microprocessors, processor cores, and the like), or a processor and memory system (e.g., implemented as a SoC), which process computer-executable instructions to control operation of the device. The processor system may be implemented as an application processor or full-power processor, such as application processor 104 described with reference to FIG. 1. A processing system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware.

Alternatively or in addition, electronic device 800 can be implemented with any one or combination of software, hardware, firmware, or fixed logic circuitry that is implemented in connection with processing and control circuits, which are generally identified at 810. Although not shown, the electronic device can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

In embodiments, electronic device 800 includes low-power processor 812 (e.g., any of microprocessors, controllers, and the like), such as low-power processor 106 described with reference to FIG. 1. Electronic device 800 may also include sensors 814, such as sensors 120 described with reference to FIG. 1. Sensors 814 may include any suitable type of sensor, such as an accelerometer, an IR sensor, magnetometer, acoustic sensor, and so on. Low-power processor 812 and sensors 814 can be implemented to facilitate adaptive detection of user proximity In at least some embodiments, low-power processor 812 is connected with sensors 814 effective to enable low-power processor 812 to monitor or receive data from sensors 814.

Electronic device 800 also includes one or more memory devices 816 that enable data storage, examples of which include random access memory (RAM), non-volatile memory (e.g., read-only memory (ROM), flash memory, EPROM, EEPROM, etc.), and a disk storage device. Memory device 816 provides data storage mechanisms to store device data 804, other types of information and/or data, and various device applications 818 (e.g., software applications). For example, operating system 820 can be maintained as software instructions with a memory device and executed by processor system 808. In embodiments, electronic device 800 includes proximity manager 822, such as proximity manager 114 described with reference to FIG. 1. Although represented as a software implementation, the proximity manager may be implemented as any form of a control application, software application, signal-processing and control module, firmware that is installed on the device, a hardware implementation of the controller, and so on. For example, proximity manager 822 may be implemented as part of low-power processor 812 or implemented in response to the execution of processor-executable instructions by low-power processor 812.

Electronic device 800 also includes an audio and/or video processing system 824 that processes audio data and/or passes through the audio and video data to an audio system 826 and/or to a display system 828. Audio system 826 and/or display system 828 may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 830. In implementations, the audio system and/or the display system are external components to the electronic device. Alternatively or in addition, the display system can be an integrated component of the example electronic device, such as part of an integrated touch interface. As described above, sensors 814 and proximity manager 822 can be implemented to facilitate adaptive detection of user proximity to present notifications via display system 828.

Although embodiments of adaptive detection of user proximity have been described in language specific to features and/or methods, the subject of the appended claims is not necessarily limited to the specific features or methods described. Rather, the specific features and methods are disclosed as example implementations of adaptive detection of user proximity.

1. A method comprising:
detecting, via a sensor of a device in a low-power state, a first environmental variance indicative of user proximity;
triggering, in response to detecting the environmental variance, a function of the device;
detecting, via the sensor, a second environmental variance indicative of user proximity;
determining, based on sensor data associated with the first and second environmental variances, that environmental conditions caused the detection of the second environmental variance; and
disregarding, in response to determining that the environmental conditions caused the detection of the second environmental variance, the second environmental variance effective to prevent false triggering of the function of the device.

2. The method as recited in claim 1, further comprising disregarding, for a predetermined duration of time, subsequently detected environmental variances effective to prevent false triggering of the function of the device for at least the predetermined duration of time.

3. The method as recited in claim 1, wherein the function of the device is implemented while the device is in the low-power state.

4. The method as recited in claim 1, wherein the environmental variance includes one of:
a sound;
a change in an orientation of the device;
a change in a position of the device;
a change in lighting;
a change in temperature; or a change in a magnetic field.

5. The method as recited in claim 1, wherein the conditions of the environment include ambient noise, ambient motion, ambient light, ambient temperature, or ambient magnetic flux.

6. The method as recited in claim 1, wherein determining whether environmental conditions caused the detection of the second environmental variance comprises calculating, based on the sensor data and a set of predefined criteria, a numerical score indicating a probability of the environmental conditions causing the detection of the second environmental variance and comparing the numerical score to a predefined threshold for detection of environmental variances.

7. The method as recited in claim 1 further comprising detecting, via the sensor of the device and while the device is in the low-power state, the environmental conditions in which the device is operating.

8. The method as recited in claim 7, wherein detecting the environmental conditions is performed in response to detecting the first environmental variance or the second environmental variance.

9. The method as recited in claim 7, wherein detecting the environmental conditions is performed at a predefined time, at predefined intervals of time, or at random intervals of time.

10. A method comprising:
receiving, from a sensor of a device in a low-power state, first data indicative of a first instance of an environmental variance associated with a user;
causing, in response to the first instance of the environmental variance, the device to visually indicate information;
receiving, from the sensor of the device, second data indicative of a second instance of the environmental variance;
analyzing, in response to the second instance of the environmental variance, the second data to determine if environmental conditions are simulating other instances of the environmental variances; and
disregarding, in response to determining that the environmental conditions are simulating other instances of the environmental variances, subsequent data received from the sensor to prevent false detection of subsequent instances of the environmental variance.

11. The method as recited in claim 10, wherein the second data is analyzed in response to receiving the second data within a duration of time following reception of the first data.

12. The method as recited in claim 10, wherein the subsequent data received from the sensor is disregarded for a predefined duration of time effective to enable detection of the subsequent instances of the environmental variance after expiration of the predefined duration of time.

13. The method as recited in claim 10, wherein the device is communicatively coupled with another device having another sensor and the method further comprises transmitting an indication to the other device that is effective to cause the other device to disregard other data received from the other sensor to prevent the other device from falsely detecting the environmental variance.

14. The method as recited in claim 10, wherein the environmental variance indicates a presence or proximity of the user.

15. The method as recited in claim 10, further comprising:
activating a display of the device to enable the visual indication of the information; and
deactivating the display of the device after a predefined duration of time or in response to user input acknowledging the information.

16. A system comprising:
a display configured to present content;
a memory configured to store content associated with notifications;
a sensor configured to provide data indicative of an environment of the system;
a proximity manager to monitor the data of the sensor and configured to:
detect, via the sensor, a first environmental variance associated with a user;
cause, in response to detecting the first environmental variance, the display to present content associated with one of the notifications;
detect, via the sensor and within an a duration of time following detection of the first environmental variance, a second environmental variance associated with the user;
analyze, in response to detecting the second environmental variance, the data provided by the sensor to determine whether environmental conditions approximate additional environmental variances associated with the user; and
cease, in response to determining that the environmental conditions approximate additional environmental variances, detection of environmental variances based on the sensor data effective to prevent false detection of a subsequent environmental variance.

17. The system as recited in claim 16, wherein the system further comprises a wireless data interface configured to enable communication with one or more sensor-enabled devices and proximity manager is further configured to cause, in response to determining that the environmental conditions approximate additional environmental variances, one of the sensor-enabled devices to cease respective detection of environmental variances effective to prevent the sensor-enabled device from falsely detecting, based on the environmental conditions, another subsequent environmental variance.

18. The system as recited in claim 17, wherein proximity manager is further configured to:
calculate a probability of the environmental conditions causing false detection of a subsequent environmental variance;
cause each of the one or more sensor-enabled devices to calculate a respective probability of the environmental conditions causing false detection of a subsequent environmental variance at each respective sensor-enabled device;
receive, from each of the one or more sensor-enabled devices, an indication of the respective calculated probabilities of false detection; and
select, from among a group comprising the system and the one or more sensor-enabled devices, the system or sensor-enabled device having the lowest probability of false detection to continue the detection of environmental variances effective to minimize the group's probability of making a false detection.

19. The system as recited in claim 18, wherein the probability or the respective probabilities are calculated based on predefined criteria or predefined thresholds associated with the detection of the environmental variances.

20. The system as recited in claim 16, wherein the system is implemented as a smart phone, a tablet computer, a laptop computer, a gaming device, a personal media device, or a navigation device.
